(19) United States
(12) Patent Application Publication
(10) Pub. No.: US 2007/0056914 A1
(43) Pub. Date: Mar. 15, 2007

(54) Agricultural cleaning and treatment apparatus and method

(76) Inventor: Joseph A. Slager, Hopedale, IL (US)

Correspondence Address: HUSCH & EPPENBERGER, LLC, 190 CARONDELET PLAZA, SUITE 600, ST. LOUIS, MO, 63105-3441, US

(21) Appl. No.: 11/521,680

(22) Filed: Sep. 14, 2006

Related U.S. Application Data
(60) Provisional application No. 60/717,505, filed on Sep. 15, 2005.

(51) Int. Cl. C02F 1/52

(52) U.S. Cl. 210/723; 210/202

(57) ABSTRACT

An agricultural cleaning apparatus includes a coarse filter assembly, a coarse filter assembly collection tank disposed to receive intermediate slurry from the coarse filter assembly, and a line disposed to receive the intermediate slurry from the coarse filter assembly collection tank. A coagulant addition device in the line adds coagulant to the intermediate slurry upon receipt of the intermediate slurry from the coarse filter assembly collection tanks. A mixer is in the line, downstream of the coagulant addition device. A flocculant addition device in the line adds flocculant to the intermediate slurry downstream of the mixer. A fine filter assembly receives the intermediate slurry from the line and filters it.

### CROSS-REFERENCE TO RELATED APPLICATIONS

This application claims priority from U.S. Provisional Patent Application No. 60/717,505 filed Sep. 15, 2005.

### BACKGROUND OF THE INVENTION

1. Field of the Invention

The present invention relates to cleaning agricultural equipment and treating the run off therefrom.

2. Related Art

Agriculture produces waste that requires treatment. In a broad variety of circumstances, beneficial treatment of agricultural waste requires the separation of solids and liquids. These circumstances may include run off from cleaning agricultural facilities such as buildings, treating mixed solid/liquid slurry material pumped from collection pits, and/or treating the run off from agricultural equipment, including tractor trailers used for the transportation of livestock. In some circumstances treated liquids may be released for further use on a farm, or may be released for discharge into a municipal sewer system, as for example in the case of cleaning transportation trucks.

Prior art treatment systems addressing the need to separate solids from liquids have too often focused on mechanical applications alone. U.S. patent application Ser. No. 10/793,085, incorporated by reference herein, is one example of an adequate mechanical screening system for separation of some particles. However, the resulting output from such exclusively mechanical apparatuses often produces an output that is insufficiently cleaned, particularly when output will be discharged into a municipal sewage system and needs to comply with certain minimum standards for content of biological material and suspended solids in the liquid.

There is a need in the art for a more comprehensive and thorough liquid/solid waste treatment apparatus and system.

Further problems arise in the installation, maintenance, and in some circumstances transportability of such an apparatus. There is a need in the art for an apparatus and system whose size, integration and components are readily installed at a wide variety of facilities, and, in other circumstances, easily transportable. There is a further need for adaptability of components. As always, there is a continuing need for economy, durability and efficiency of operation and maintenance.

### SUMMARY OF THE INVENTION

An agricultural cleaning apparatus includes a coarse filter assembly, a coarse filter assembly collection tank disposed to receive intermediate slurry from the coarse filter assembly, and a line disposed to receive the intermediate slurry from the coarse filter assembly collection tank. A coagulant addition device in the line adds coagulant to the intermediate slurry upon receipt of the intermediate slurry from the coarse filter assembly collection tanks. A mixer is in the line, downstream of the coagulant addition device. A flocculant addition device in the line adds flocculent to the intermediate slurry downstream of the mixer. A fine filter assembly receives the intermediate slurry from the line and filters it.

An alternative embodiment has a single filter, the filter is disposed to receive a slurry after coagulant has been added, mixed and then a flocculant has been added.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of the system of the present invention.

FIG. 2 is a close-up representation of transfer line 30 including a mixer.

FIG. 3 is schematic representation of an alternative embodiment.

### DETAILED DESCRIPTION OF THE PREFERRED EMBODIMENTS

The following description of the preferred embodiment(s) is merely exemplary in nature and is in no way intended to limit the invention, its application, or uses.

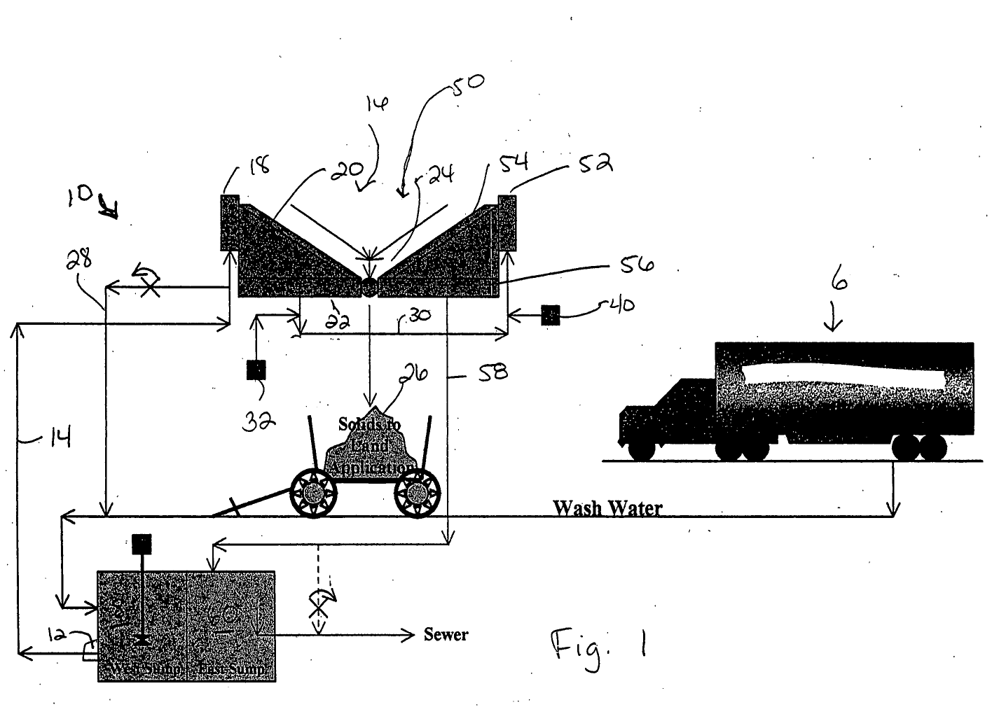

Referring now to the drawings where like reference numbers indicate like elements, FIG. 1 is a schematic representation of the apparatus and system of the present invention. In the depicted embodiment an agricultural truck 6 is being cleaned. Truck 6 is washed with water, as for example a high pressure hose, using known techniques. Waste water is collected in sump 8. Thereafter the system 10 of the present invention is put into use. From mixed waste sump 8 the waste slurry is pumped with pump 12 through a raw feedline 14 to a first reservoir 18. In the depicted embodiment, the pump 12 used is a three horsepower pump having a flow rate of up to 160 gallons per minute. The first reservoir is part of a coarse filter assembly 16.

First reservoir 18 is disposed to evenly distribute the mixed waste slurry onto a first screen that is a coarse screen 20. Reservoir 18 has a trap or screen to catch oversized particles such as rocks. The reservoir fills to a preconfigured level and then discharges onto the top of the first coarse screen 20. Thus, the reservoir 18 serves to properly spread the mixed waste slurry to flow evenly over the screen.

In the depicted embodiment, the coarse screen 20 is an angled screen over which the mixed waste slurry is poured. Solid waste rolls, tumbles or slides down the slope of the coarse screen 20 and off of the screen. Smaller particles and the liquid portion of the slurry drop through the holes in the screen to be collected in coarse filter tank 22. In the depicted embodiment the first coarse screen is made of sheet metal with holes fabricated therein that are about 1/16^{th} inch in diameter. It is anticipated that in most agricultural applications or applications being used to clean agricultural equipment such as trucks at truck stops, that screens with holes from 1/32^{nd} to ⅛^{th} inch would be most applicable. However, it is within the scope of the present invention that other diameter perforations or slotted screens may be used. This first processing step produces in the first filter tank 22 intermediate slurry comprised of smaller particulate matter and water. Larger particulate matter has rolled or slid down the coarse screen 20. At the bottom of the coarse screen 20 a roller system 24 receives these solids and pinches them between rollers to compress them further. Water produced from this application of pressure is returned to the mixed waste sump 8.

Overflow from the reservoir 18 is returned to the mixed waste slurry sump via overflow line 28. Solids dropping through the roller system 24 are collected in receptacle 26 and removed for application elsewhere.

Coarse filter tank 22 has an exit to intermediate transfer line 30 which receives the intermediate slurry from the coarse filter tank 22. Material entering transfer line 30 may be pumped with flow rate up to that of pump 12. Transfer line 30 is described in greater detail below. Proximate to the coarse filter tank 22 and disposed to apply a next process step is a coagulant addition device 32. In the depicted embodiment, this device is a diaphragm pump. A hopper or tank (not shown in FIG. 1) contains a coagulant, as is more fully described below. In the depicted embodiment, the first coarse diaphragm pump has a flow rate of 4 to 20 gallons per hour. A preconfigured or user adjustable amount of coagulant is added through the diaphragm pump. The amount of coagulant added may be controlled either by adjusting the diaphragm injection rate, and/or by adjusting the overall flow through rate of the intermediate slurry.

To be effective, the coagulant requires efficient mixing and time. After the addition of coagulant the next process step is mixing. It is within the scope of the present invention that mixing be had with static internal baffles, an active mixer, an open channel or by other means. In the depicted embodiment, as explained in further detail below, mixing is by a series of baffles; that is, a zigzag or serpentine configuration of transfer line 30.

The next process step is addition of a flocculant with a flocculant addition device 40. The flocculant used in the depicted embodiment is described in greater detail below. Like the coagulant, the flocculent is added in the depicted embodiment with a diaphragm pump. The proportions of flocculant used may be preconfigured or user adjustable. This is achieved by adjusting the amount of flocculant inserted in the line 30 through the diaphragm pump and/or adjusting the overall throughput of the line 30 with the pump 32 and/or pump 40.

The flocculant is added proximate to the second, fine filter assembly 50. The second filter assembly is comprised of a second reservoir 52, a fine screen 54 and discharge 58. A second filter tank 56 may be included. The intermediate slurry with the coagulant and flocculant added is received at second reservoir 52. Like first reservoir 18, the fine filter reservoir 52 is disposed to collect the intermediate slurry and evenly pour it over the fine screen 54 at the top. In the depicted embodiment, the fine screen 54 is a slanted woven screen of 80 mesh. While it is anticipated that screens of 50 to 200 mesh will be most applicable to the fixed installation, agricultural facility, agricultural structure and agricultural machine cleaning installations of some anticipated uses, other meshes remain within the scope of the present invention. Similar to the coarse filter, the fine filter allows water to drop through the screen and the coagulated and flocculated particulate matter to roll or slide across and down the angled screen. Unlike the first filter step, the solid material arriving at the bottom of screen 54 is not processed through any pinch roller or otherwise compressed. From the second filter collecting tank 56, return line 58 takes the finely filtered water to final sump 60. Return line 58 may be pumped to final sump 60. From final sump 60, the filtered fluid is now ready for return to a municipal sewer service or other uses in an agricultural installation.

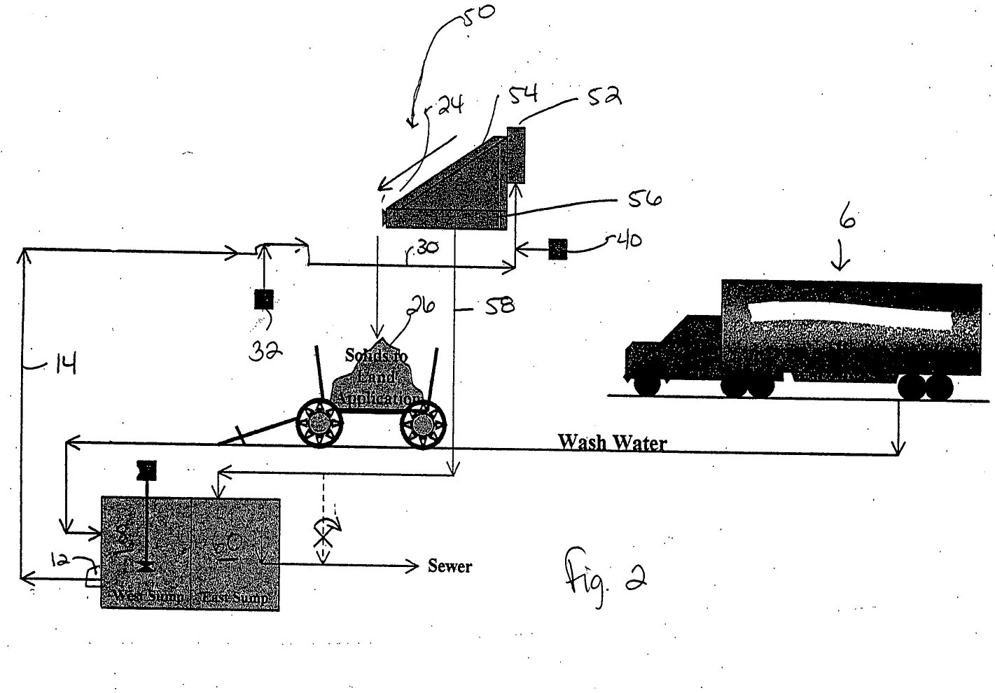

FIG. 2 is a close up of the transfer line 30, showing the static mixing construction. The transfer line receives intermediate slurry from the coarse filter assembly at the lower left of FIG. 2 where coagulant is added with a coagulant adding device (diaphragm pump) 32. Optionally, a flow meter may be installed in the line. Thereafter, in order that the coagulant may have sufficient time to chemically act upon particulate waste matter, the length of transfer line 30 is increased, and correspondingly the flow through time is also increased, by incorporating a zigzag or serpentine configuration 34. In the depicted embodiment, transfer time from the addition of coagulant to the addition of flocculant is approximately 33 seconds at a flow rate of 90 gallons per minute. The multiple comers in the line 30 created by this serpentine array increase the effective mixing of the coagulant by creating turbulence which promotes mixing of the intermediate slurry with the coagulant. A turn in transfer line 30 is represented on the right hand side of FIG. 2, corresponding to the need of the line to raise the intermediate slurry from the bottom of the coarse filter tank 22 to the top of the fine filter assembly reservoir 50. Further zigzags are installed in transfer line 30 and represented in the side view at 36. Thereafter, in a post mixing process step, flocculant is added with flocculant adding device 40. Flocculant adding device 40 may be a diaphragm pump or a positive displacement pump. Thereafter the intermediate slurry is deposited in the fine filter assembly 50 reservoir 52 in the upper left hand corner of the FIG. 2.

In the depicted embodiment, the fine filter assembly includes a screen cleaning device. The disclosure of U.S. patent application Ser. No. 10/793,085 is incorporated by reference as if fully set forth herein. The screen cleaning device includes a moveable pressurized line underneath the screen that incorporates a plurality of nozzles. The nozzles are oriented upwards, towards the screen where they spray pressurized water upwards through the screen in order to keep the perforations and/or screen mesh clear.

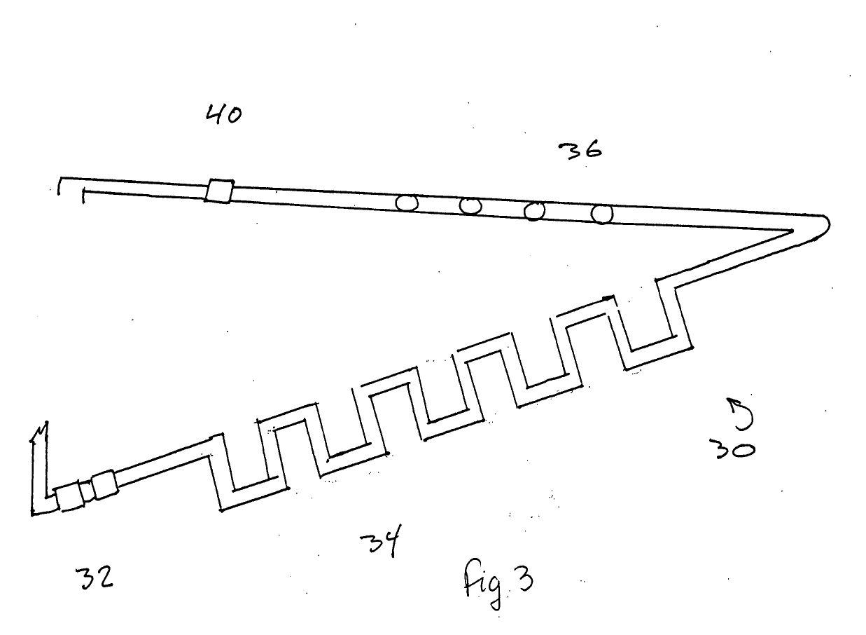

FIG. 3 depicts an alternative embodiment of the present invention. At some applications, a single screen may be adequate. Hence, in the apparatus depicted in FIG. 3, sump pump 12 removes waste water to be treated from source 8 and transfers in via line 14 straight into the transfer line 30. Before the transfer line 30, the coagulant addition device 32 adds coagulant as it did in the previous described embodiment. Thereafter, all other structure of the apparatus and steps of the method are as described previously, including, generally, the addition of coagulant, a mixing apparatus and step, the addition of flocculant, and screening.

Coagulants

A wide variety of coagulants may be advantageously used in combination with the structures of the present invention. These may include organic and non-organic coagulants. They may include straightforward chemical compounds such as aluminum sulfate, iron sulfate or other ferric compositions. They may also include commercially available chemical compounds, such as Magnasol 2765 offered by Ciba.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. An agricultural slurry cleaning apparatus comprising:
a pump, said pump being disposed to receive a waste slurry and propel the waste slurry into a first line;
a coagulant addition device in operative communication with said first line such that coagulant is added to the waste slurry;
a mixer line, said mixer being downstream of said coagulant additional device;
a flocculent addition device in operative communication with said mixing line such that flocculant is added to the slurry downstream of said mixer line;
a filter assembly disposed to receive the slurry from a fluid communication with said flocculent addition device and filter the slurry.

2. An agricultural equipment cleaning apparatus comprising:
a coarse filter assembly said coarse filter assembly being disposed to receive a mixed waste slurry;
a coarse filter assembly collection tank disposed to receive intermediate slurry from said coarse filter assembly;
a line disposed to receive the intermediate slurry from said coarse filter assembly collection tank;
a coagulant addition device in operative communication with said line such that coagulant is added to the intermediate slurry substantially upon receipt of the intermediate slurry from said coarse filter assembly collection tank;
a mixer in said line, said mixer being downstream of said coagulant addition device;
a flocculant addition device in operative communication with said line such that flocculant is added to the intermediate slurry downstream of said mixer; and
a fine filter assembly disposed to receive the intermediate slurry from said line and filter the intermediate slurry.

3. The apparatus of claim 2 wherein said coagulant addition device is a diaphragm pump.

4. The apparatus of claim 2 wherein said coagulant addition device is a positive displacement pump.

5. The apparatus of claim 2 wherein said flocculant addition device is a positive displacement pump.

6. The apparatus of claim 2 wherein said flocculant addition device is a diaphragm pump.

7. The apparatus of claim 2 further comprising a fine filter assembly collection tank adapted to discharge treated water to a sewer.

8. The apparatus of claim 2 further comprising a fine filter assembly collection tank adapted to discharge treated water to a reservoir.

9. The apparatus of claim 2 further comprising a fabric web filter disposed to receive a volume of treated water from said fine filter apparatus.

10. The apparatus of claim 2 further comprising a settling tank disposed to receive a volume of treated water from said fine filter apparatus.

11. The apparatus of claim 2 further comprising a compression apparatus designed to compress solids received from said coarse filter apparatus.

12. The apparatus of claim 2 wherein at least one of said coarse filter apparatus or said fine filter apparatus includes an angled filter disposed to receive a downward flow of slurry.

13. The apparatus of claim 2 wherein said coarse filter apparatus includes a filter having holes in a range of about 1/32^{nd} of inch in diameter to about ⅛^{th} of an inch in diameter.

14. The apparatus of claim 2 wherein said fine filter apparatus includes a mesh filter in a range from about 50 mesh to about 200 mesh.

15. The apparatus of claim 2 further comprising at least one overflow line from said coarse filter assembly to an originating sump.

16. The apparatus of claim 2 wherein said mixer is a serpentine configuration of said line.

17. The apparatus of claim 2 wherein said mixer is selected from the group consisting of internal baffles, an open throat line and an active mixer.

18. A method for cleaning agricultural waste water from agricultural equipment where the agricultural equipment has been washed with water, said method comprising:
separating large solids with a coarse filter assembly;
adding coagulant to intermediate slurry received from said coarse filter assembly;
mixing said intermediate slurry after said addition of coagulant;
adding flocculant to said intermediate slurry after said step of mixing; and
filtering said intermediate slurry with a fine filter assembly.

19. The method of claim 18 wherein said agricultural waste water is received from a storage device.

20. The method of claim 18 wherein said coagulant addition step uses a diaphragm pump.

21. The method of claim 18 wherein said coagulant addition step uses a positive displacement pump.

22. The method of claim 18 wherein said flocculent addition step uses a diaphragm pump.

23. The method of claim 18 wherein said flocculant addition step uses a positive displacement pump.

24. The method of claim 18 further comprising a step of discharging from a fine filter assembly collection tank treated water to a sewer.

25. The method of claim 18 further comprising a step of discharging from a fine filter assembly collection tank treated water to a reservoir.

26. The method of claim 18 further comprising a step of filtering with a fabric web filter disposed to receive a volume of treated water from said fine filter assembly.

27. The method of claim 18 further comprising a step of settling with a settling tank disposed to receive a volume of treated water from said fine filter assembly.

28. The method of claim 18 further comprising a step of compressing with a compression apparatus designed to compress solids received from said coarse filter apparatus.

29. The method of claim 18 wherein at least one of said coarse filter steps or said fine filter step includes an angled filter receiving a downward flow of slurry.

30. The method of claim 18 wherein said coarse filter step uses a filter having holes in a range of about 1/32^{nd} of inch in diameter to about ⅛^{th} of an inch in diameter.

31. The method of claim 18 wherein said coarse filter step uses a filter having holes in a range of about 0.010 inch in diameter to about 0.125 inch in diameter.

32. The method of claim 18 wherein said fine filter step uses a mesh filter in a range from about 50 mesh to about 200 mesh.

33. The method of claim 18 further comprising a step of returning overflow using at least one overflow line from said coarse filter assembly to an originating sump.

34. The method of claim 18 wherein said mixing step uses a serpentine configuration in a line between said coagulant addition step and said flocculant addition step.

35. The method of claim 18 wherein said mixing step uses a mixer is selected from the group consisting of internal baffles, an open throat line and an active mixer.
